(19) United States
(12) Patent Application Publication
(10) Pub. No.: US 2002/0150225 A1
(43) Pub. Date: Oct. 17, 2002

(54) Method and apparatus for providing reverse-hold capability for telephone users

(76) Inventor: Christopher Gerald Hudel, Pineville, NC (US)

Correspondence Address: HEWLETT-PACKARD COMPANY, Intellectual Property Administration, P.O. Box 272400, Fort Collins, CO, 80527-2400, US

(21) Appl. No.: 09/834,236

(22) Filed: Apr. 11, 2001

(51) Int. Cl. H04M 3/42

(52) U.S. Cl. 379/210.01

(57) ABSTRACT

The present invention provides a method and apparatus for enabling a first telephone user who has been placed on hold by a second telephone user to be notified when the hold has been removed. When the first user is placed on hold, the first user activates the reverse-hold feature, preferably by entering a particular code on the telephone keypad. The first user may then make another telephone call or hang up the telephone without completely severing the communication link with the second user. When the second user removes the hold, a notification that the hold has been removed will be communicated to the first user. If the first user is engaged in another telephone call when the notification is communicated, the telephone will produce a tone similar or identical to that provided by the Call-Waiting feature currently available to telephone subscribers. If the first user has placed the telephone on-hook and the notification is communicated, the telephone will ring, preferably distinctively.

### TECHNICAL FIELD OF THE INVENTION

The present invention relates to telephony and, more particularly, to a reverse-hold feature that enables a calling party who has been placed on hold by a called party to be notified when the called party becomes available.

### BACKGROUND OF THE INVENTION

Customer support centers often place customers who contact them by telephone in a holding queue until a customer support representative is available to assist the customer. The customers are normally assisted on a first-come-first-serve bases. During the time period in which the customer is on hold, the customer must wait on the line until the representative is available to assist them. If the customer hangs up the telephone, the call will be terminated without the customer receiving assistance. Therefore, the customer must remain on the line and available so that when the hold is released by the representative, the customer is ready to speak with the representative. If the customer is not ready and available to speak with the representative when the hold is released, the representative typically will terminate the call.

Although the well known “Call-Waiting” feature provided by telephone companies allows the customer to receive another telephone call without terminating the call to the customer support center, it does not provide the customer with the ability to simply hang up the telephone without terminating the connection with the customer support center. Also, if the customer having the “call waiting” feature enabled switches to another call while on hold with the customer support center, the connection with the customer support center will typically be terminated by the representative if the hold is removed before the customer returns to that call. If the customer has switched to another call, the customer is not notified when the representative is available for assistance.

It would be advantageous to provide the customer with the ability to hang up the telephone or make other telephone calls, without the call being terminated when it is removed from the holding queue. It would also be advantageous to provide a feature that would, in the case where the customer has hung up the telephone (i.e., placed the telephone on-hook), prevent the call from being terminated and also notify the customer when the hold has been removed. It would also be advantageous to provide the customer with the ability to make other calls while on hold and to be notified when the hold is removed. The present invention provides a method and apparatus that enable these advantages to be realized through the use of a reverse-hold feature, as discussed below in detail.

### SUMMARY OF THE INVENTION

The present invention provides a method and apparatus for providing a reverse-hold feature that enables a first telephone user who has been placed on hold by a second telephone user to be notified when the hold has been removed. When the first telephone user is placed on hold, the first telephone user activates the reverse-hold feature. While the reverse-hold feature is activated, the first telephone user may make another telephone call or hang up the telephone without completely severing the communication link with the second telephone user. When the second telephone user removes the hold, a notification that the hold has been removed will be communicated to the first telephone user.

Preferably, the reverse-hold feature is activated by entering a particular code on the telephone keypad. A tone decoder decodes the code, which corresponds to one or more key entries on the keypad, and provides the decoded signal to a processor. The processor corresponds to the apparatus of the present invention. The processor performs the reverse-hold algorithm. When the reverse-hold feature is activated, the processor causes an announcement to be played so that, when the second telephone user takes the call, thereby causing the hold to be removed, the second telephone user will hear the announcement. The announcement will include a verbal prompt that informs the second telephone user of the key entry or entries on the telephone keypad that need to be made in order to cause the connection between the first and second telephone users to be re-established. Upon pressing the proper key(s), a notification that the hold has been removed will be communicated to the telephone of the first telephone user.

If the first telephone user is engaged in another telephone call when the notification is communicated, the telephone will produce a sound, preferably a tone similar or identical to that provided by the Call-Waiting feature currently available to telephone subscribers. If the first telephone user has placed the telephone on-hook and the notification is communicated while the telephone is on-hook, the telephone will ring. Preferably, the ring will be distinctive so that the first telephone user will know that the ring is associated with the second telephone user and that the hold has been removed.

These and other objects and features of the present invention will become apparent from the following description, drawings and claims.

### BRIEF DESCRIPTION OF THE DRAWINGS

FIG. 1 is a block diagram of a network in which the method and apparatus of the present invention may be incorporated.

FIG. 2 is a block diagram of the central office shown in FIG. 1.

FIG. 3 is a block diagram of the switching module of the central office shown in FIG. 2, which preferably incorporates the method and apparatus of the present invention.

FIG. 4 is a flow chart demonstrating the method of the present invention in accordance with the preferred embodiment.

### DETAILED DESCRIPTION OF THE INVENTION

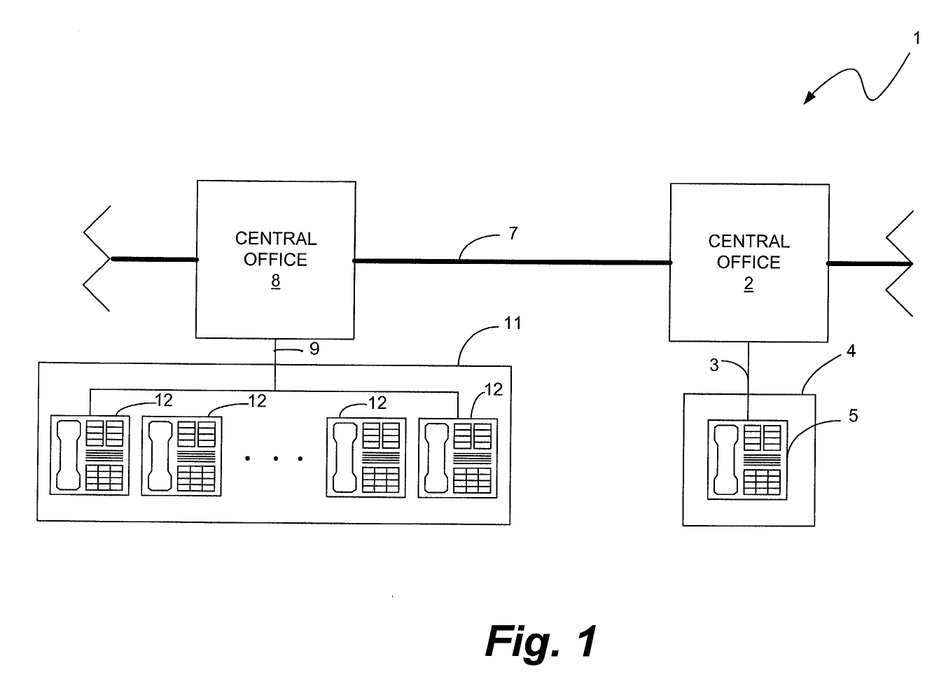

FIG. 1 illustrates a block diagram of a POTS (Plain Old Telephone Service) network 1 in which the method and apparatus of the present invention may be implemented. The present invention is directed to a reverse-hold mechanism that enables a calling party who has been placed on hold to be notified when the called party has removed the hold. The calling party who has been placed on hold by a called party can make other calls or hang up the telephone without terminating the connection with the called party. If the calling party has hung the telephone up after being placed in the holding queue, the calling party's telephone will ring when the called party releases the hold, thereby notifying the calling party that the hold has been released. During the time period after the hold has been released and before the calling party answers the telephone, a mess age preferably will be played to the called party that informs the called party that the calling party is currently waiting to be taken off hold and that the calling party will be notified that they have been taken off hold if and when the called party depresses a designated button on the telephone.

If the called party releases the hold while the calling party is engaging in another telephone, the calling party will preferably here a tone identical or similar to that normally provided by the Call-Waiting feature to inform the user of an incoming telephone call. In accordance with the present invention, this tone preferably will be used to notify the calling party that the hold has been released by the called party. The calling party may then press the “FLASH” button, or some other designated button on the telephone, to thereby cause the calling party's telephone to be reconnected with the called party's line. During the time period after the hold has been released and before the calling party has been reconnected to the called party's line, the message discussed above preferably will be played to the called party to inform them that the calling party is currently waiting to be taken off hold and that the calling party will be notified that they have been taken off hold if and when the called party depresses a designated button on the telephone.

In accordance with the preferred embodiment, the apparatus of the present invention is located at a central office (CO) of a communications network and is a computer used for executing software relating to telephone user options, such as, for example, the well known Call-Waiting and Caller-ID features that are typically offered as additional calling features to telephone subscribers by telephone companies. Therefore, the method of the present invention preferably is performed in software being executed by a computer at the CO. Thus, the method of the present invention preferably is implemented in the form of a computer algorithm being performed by the computer.

The present invention will now be discussed with reference to these preferred embodiments, although it is not limited to being performed in software by a computer at the CO. Those skilled in the art will understand that other locations within the telephone network may also be suitable for implementation of the present invention. Those skilled in the art will also understand that functions performed by a computer executing software may alternatively be implemented solely in hardware, or in a combination of hardware and software.

Also, since one of the practical applications of the present invention is to enable a calling party to utilize the reverse-hold feature when the calling party has been placed on hold by a customer support center, the present invention will be described with reference to a home telephone user who calls a customer support center for assistance and has been placed on hold by the customer support center. However, it should be noted that the present invention is not limited to any particular types of “calling” or “called” parties, as will be understood by those skilled in the art. The present invention is applicable to and advantageous in any situation where a telephone user has been placed in a holding queue.

FIG. 1 illustrates a network 1 comprising a first CO 2 that is connected by a copper wire pair 3, also commonly referred to as a twisted pair, to a customer premises 4. A telephone 5 located at the customer premises 4 may be used by a telephone subscriber to place and receive telephone calls. The central office 2 is connected by a trunk 7 to a second CO 8. The second CO 8 is connected by a copper pair 9 to a customer support center 11, which comprises a bank of telephones 12 that are used by employees at the customer support center to assist callers who call in for assistance.

Central offices 2 and 8 provide the switching operations for connecting a calling party located at the customer premises 5 with a called party located at the customer service center 11. However, although two COs are illustrated, it is possible that both the subscriber premises and the customer support center are serviced by the same CO. The present invention is equally applicable in both situations.

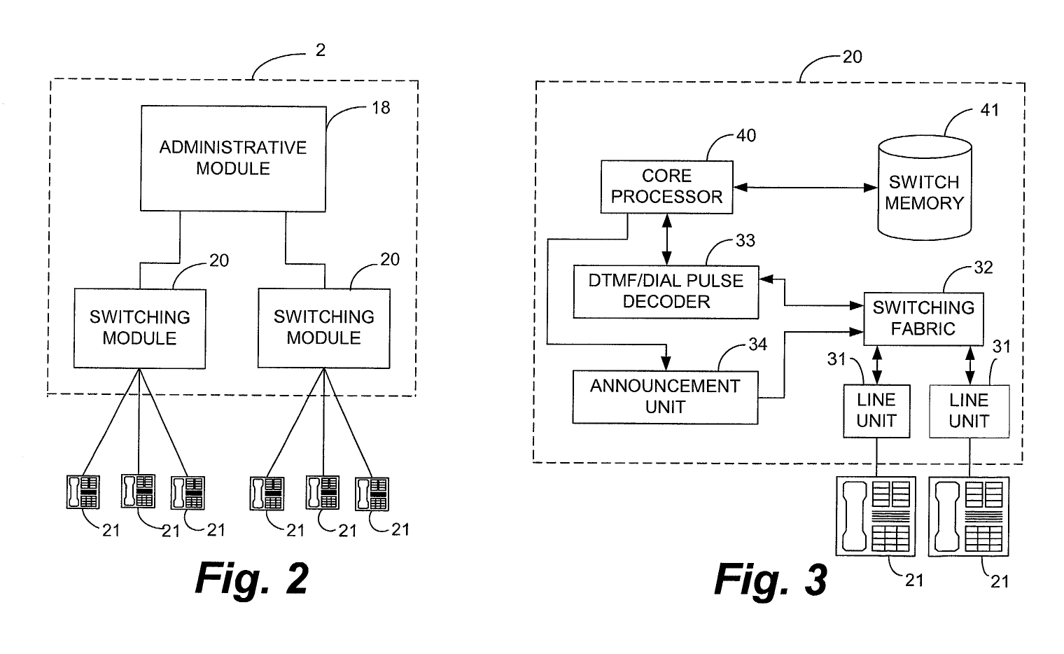

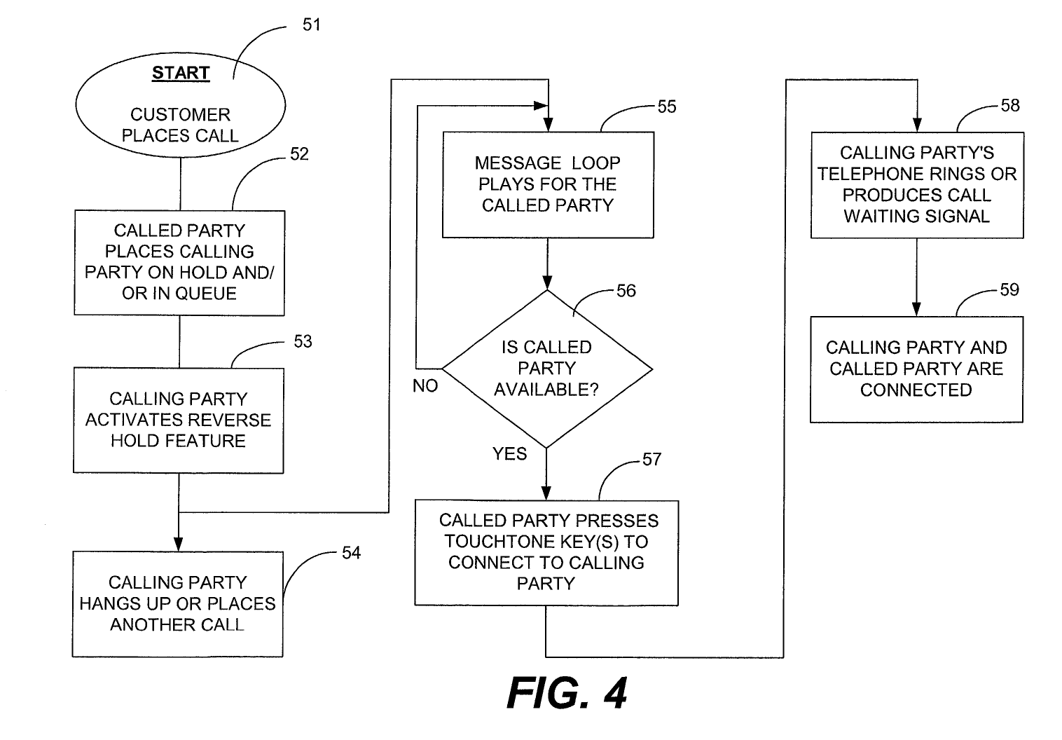

FIG. 2 is a block diagram that illustrates the CO 2. Since the COs may be, but need not be, identical in design and configuration for the purposes of the present invention, only the components of one of the COs, CO 2, will be discussed herein. The CO comprises an administrative module 18 and a plurality of switching modules 20. The switching modules 20 are switched to set up call sessions for the telephones connected to the CO 2. The administrative module 18 typically handles billing tasks for the CO 2 to create billing files that are ultimately dumped to a location designated by the telephone company, where they are used to generate customer bills. The administrative module 18 typically comprises a computer (not shown) programmed to perform these tasks.

The switching modules 20 perform the switching of the customer circuits in response to call signaling information received by the CO 2 from signaling processors (not shown) that utilize a communications link that is separate from that used for transmitting voice information. This is generally known as out-of-band call signaling. Each of the switching modules 20 comprises a computer for performing the switching functions. These computers are programmed with software programs that enable various subscriber features, such as, for example, the aforementioned Call-Waiting and Caller-ID features, to be provided to telephone customers. Preferably, this computer is utilized in accordance with the present invention to provide reverse-hold capability to telephone users. Therefore, the present invention preferably is performed by a computer of the switching module 20 that runs software that performs the reverse-hold algorithm, which corresponds to the method of the present invention.

FIG. 3 is a block diagram of the switching module 20 shown in FIG. 2. The switching module 20 comprises line units 31 that comprise circuitry (not shown) that terminates the telephone lines connected to the telephones 21. For ease of illustration, only two telephones 21 are shown, although, in reality, a large number of telephones are controlled by the switching module 20. The switching fabric 32 controls the multiplexing and demultiplexing of the telephones 21 communicating with the switching module 20. The switching fabric 32 is in communication with a dual tone multifrequency (DTMF)/dial pulse decoder 33, which decodes the frequencies entered on the keypads of the telephones 21. The DTMF/dial pulse decoder 33 then provides digit reports corresponding to the decoded frequencies to a core processor 40 of the switching module 20.

The core processor 40 receives the digit reports and determines whether a call is to be routed or whether a feature is to be activated. The core processor 40 runs software programs and processes data stored in switch memory device 41. In accordance with the present invention, the core processor 40 performs the reverse-hold algorithm of the present invention. Therefore, the core processor will be programmed to interpret the digit reports received from the DTMF/Dial pulse decoder 33, which correspond to buttons pressed on the telephone keypad, and to perform take the appropriate action.

The switching modules that are connected to both the calling and called parties' telephones preferably will be configured with the same intelligence so that all aspects of the reverse-hold algorithm can be performed by both of the switching modules. This does not mean that the implementation of the invention at each switching module must be the same, but only that the switching modules be configured to recognize the same digit reports and to perform the associated tasks. For example, in the case where the reverse-hold algorithm is implemented in software being executed by the core processor 40, it is not necessary that the software running on the core processors of each switching module be the same, but only that the software enable each core processor to perform the necessary tasks.

The core processor 40 will cause a prerecorded announcement to be played back by the announcement unit 34 when certain conditions occur. The announcement unit 34 may be comprised in what is commonly referred to as a global digital service unit (not shown), which contains a variety of prerecorded announcements that serve subscribers. In accordance with the preferred embodiment, the announcement unit 34 issues a recorded announcement that informs the party removing the hold that the other party is currently unavailable and to press a certain key or a series of certain keys to cause the party to be notified that the hold has been removed.

For example, in the case where the calling party has been placed on hold by a customer support representative, upon removing the hold, the representative might hear “The party that was on hold is available and has been waiting to be assisted for “X” minutes. To speak with that party, please press the pound key.” In this example, X represents the amount of time that the party has been on hold. When the representative presses the “#” key, the telephone of the calling party will ring. Preferably, the ring preferably will be distinctive, i.e., different from the normal ring. The calling party will be connected with the representative upon answering the telephone. In the case where the calling party is engaged in another telephone call, when the “#” key is depressed by the representative, the calling party will here a sound similar or identical to the sound that is used to inform a party having Call-Waiting that they have an incoming call. If the calling party presses the “FLASH” key upon hearing this sound, the calling party will be reconnected with the representative.

Of course, the key(s) or buttons on the telephone keypad that are used as codes to inform the core processor 50 take any of these computer-controlled actions are designated designer of the hardware and/or software used to implement the reverse-hold algorithm. The present invention is not limited with respect to the keys that are used for this purpose. Rather, the limiting factor in selecting the code(s) is that it cannot be the same as any code already used with the core processor 40. Any button or series of buttons pressed on the telephone keypad will be decoded by the DTMF/Dial pulse decoder 33 and the decoded output will be provided to the core processor 40 in the form of digit reports. The core processor 40 will then interpret the digit reports and take the appropriate action.

In accordance with the preferred embodiment, a telephone user who has been placed on hold will press the “FLASH” key on the telephone keypad to activate the reverse-hold algorithm. Alternatively, a different button or series of buttons on the telephone keypad can be used as the code for activating the reverse-hold algorithm. In accordance with the preferred embodiment, the reverse-hold algorithm of the present invention operates in conjunction with the well known Call-Waiting feature. Therefore, when a party who has been placed on hold presses the “FLASH” key followed by another particular key or series of keys, the reverse-hold algorithm will cause the core processor 40 to interpret the digit report associated with the “FLASH” key as a request to activate reverse-hold. When reverse-hold is activated, the core processor will cause the announcement unit to play a message, such as that mentioned above, for example, to the party that initiated the hold. In part, that message will inform the party that pressing any key, a particular key, or a particular series of keys will cause the other party to be notified that they have been taken off hold. When the appropriate code is entered, the other party will be notified in the aforementioned manner.

The reverse-hold algorithm of the present invention in accordance with the preferred embodiment will now be discussed with reference to the flow chart shown in FIG. 3. Again, it will be assumed that the calling party is a customer seeking assistance and that the called party is a customer support center. The customer places a call to the customer support center and is placed on hold, as indicated by blocks 51 and 52. The customer then activates the reverse-hold mechanism by pressing the appropriate key(s), as indicated by block 53. The customer then hangs up the telephone or places another call, as indicated by block 54. Activation of the reverse-hold mechanism causes a message loop to be played to the customer support representative, as indicated by block 55. As the message is played, determinations are periodically made as to whether or not the hold has been removed, as indicated by block 56.

When a determination is made at block 56 that the hold has been removed, upon hearing the message, the representative presses the designated key(s), as indicated by block 57. The customer is then notified by a ring or by a Call-Waiting type sound that the hold has been removed, as indicated by block 58. When the customer answers the telephone or presses a designated key(s), the customer and the representative will be connected, as indicated by block 59.

It should be noted that the present invention is equally applicable to landline networks and to mobile and wireless networks. Those skilled in the art will understand the manner in which the present invention can be adapted for any of these types of networks. Also, the present invention is not limited to any particular type of telephone. Regular telephones, such as those commonly used in home and office environments are suitable for use with the present invention. In this case, the intelligence needed for performing the reverse-hold capability preferably is implemented at the switching module, as discussed above in detail. Alternatively, a “smart” telephone could be used with the present invention. This type of telephone typically has built-in logic that enables many features not found in regular telephones to be available to the user. In this case, some or all of the intelligence needed to perform the reverse-hold algorithm will be implemented as logic in the smart telephone.

The present invention also has applicability to Internet telephony. In this case, the intelligence needed to perform the reverse-hold feature preferably would be comprised in logic located at an Internet Service Provider (ISP). Also, rather than, or in addition to, using an audio notification (e.g., a ring, an audio message, a call waiting beep, etc.), with respect to IP telephony, a plurality of web-based options are available for use with the present invention. Those skilled in the art will understand how these various alternative embodiments can be accomplished in view of the discussion provided herein.

It should be noted that the present invention has been described with reference to the preferred embodiment and that the present invention is not limited to this embodiment. Those skilled in the art will understand the manner in which modifications can be made to the embodiment discussed herein without deviating from the scope of the present invention. For example, those skilled in the art will understand the manner in which various software programs can be written to perform the reverse-hold algorithm of the present invention. Any program capable of implementing the reverse-hold algorithm of the present invention is within the scope of the present invention. Similarly, those skilled in the art will understand the manner in which hardware or a combination of hardware and software can be configured and utilized to implement the reverse-hold mechanism of the present invention.

What is claimed is:

1. An apparatus for providing a reverse-hold feature, the reverse-hold feature enabling a first telephone user of a first telephone who has been placed on hold to be notified when the hold has been removed, the apparatus comprising:
first logic, the first logic receiving a first signal, the first logic being configured to interpret the received first signal to determine whether the received first signal corresponds to a request to activate a reverse-hold feature, wherein if the first logic determines that the received first signal corresponds to a request to activate the reverse-hold feature, the first logic causes the reverse-hold feature to be activated, wherein activation of the reverse-hold feature enables the first telephone user to be notified when the hold has been removed.

2. The apparatus of claim 1, wherein, while the reverse-hold feature is activated, the first telephone user can hang up the first telephone without severing a communication link between the first telephone user and a party that caused the first telephone user to be placed on hold.

3. The apparatus of claim 1, wherein, while the reverse-hold feature is activated, the first telephone user can make another telephone call from the first telephone without severing a communication link between the first telephone user and a party that caused the first telephone user to be placed on hold.

4. The apparatus of claim 1, wherein, while the reverse-hold feature is activated, a message is communicated to a party that caused the first telephone user to be placed on hold, wherein the message is intended to inform the party of how to reestablish communications with the first telephone user.

5. The apparatus of claim 1, wherein if the hold is removed while the reverse-hold feature is activated, the first logic will determine whether one or more signals received by the first logic indicate that a party that placed the first telephone user on hold has entered a request to provide notification to the first telephone user that the hold has been removed, wherein if the first logic determines that a request to provide notification to the first telephone user that the hold has been removed has been entered, the first logic will cause a first notification to be generated and to be communicated to the first telephone user to inform the first telephone user that the hold has been removed.

6. The apparatus of claim 5, wherein if the first telephone user is using the first telephone to engage in another telephone call when the first notification is communicated to the first telephone of the first telephone user, the first telephone user will hear at least one particular tone indicating that the hold has been removed, and wherein if the first telephone user enters a particular code on the telephone keypad of the first telephone after hearing said at least one particular tone, communications will be re-established between the first telephone user and the party that placed the first telephone user on hold.

7. The apparatus of claim 5, wherein the first notification causes the first telephone of the first telephone user to ring if the first telephone of the first telephone user is on-hook when the first notification is communicated to the first telephone of the first telephone user, wherein if the first telephone user answers the first telephone in response to the ringing, communications will be re-established between the first telephone user and the party that placed the first telephone user on hold.

8. The apparatus of claim 5, wherein when the first telephone of the first telephone user rings in response to the first notification, the ring is distinguishable from a ring normally produced by the first telephone of the first telephone user when calls are received by the first telephone of the first telephone user.

9. The apparatus of claim 1, wherein the first telephone is a smart telephone.

10. The apparatus of claim 1, wherein the telephone is an Internet telephone.

11. The apparatus of claim 1, wherein the first telephone is a landline telephone.

12. An apparatus for providing a reverse-hold feature at a central office (CO) of a network, the CO comprising a switching module, the apparatus being comprised by the switching module, the reverse-hold feature enabling a first telephone user who has been placed on hold to be notified when the hold has been removed, the apparatus comprising:
a processor configured to interpret a received signal and to determine whether the received signal corresponds to a request to activate a reverse-hold feature, wherein if the processor determines that the received signal corresponds to a request to activate the reverse-hold feature, the processor causes the reverse-hold feature to be activated, wherein activation of the reverse-hold feature enables the first telephone user to be notified when the hold has been removed.

13. The apparatus of claim 12, wherein, while the reverse-hold feature is activated, the first telephone user can hang up the telephone without severing a communication link between the first and a party that caused the first telephone user to be placed on hold.

14. The apparatus of claim 12, wherein, while the reverse-hold feature is activated, the first telephone user can make another telephone call without severing a communication link between the first and a party that placed the first telephone user on hold.

15. The apparatus of claim 12, wherein, while the reverse-hold feature is activated, the first logic causes a message to be communicated to a party that placed the first telephone user on hold to inform the party of how to re-establish communications with the first telephone user.

16. The apparatus of claim 12, wherein if the hold is removed while the reverse-hold feature is activated, the processor will determine whether one or more signals received indicate that the party that placed the first telephone user on hold has entered a request to provide notification to the first telephone user that the hold has been removed, wherein if the processor determines that the party has entered a request to provide notification to the first telephone user that the hold has been removed, the processor will cause a first notification to be generated and to be communicated to the telephone of the first telephone user to inform the first telephone that the hold has been removed.

17. The apparatus of claim 16, wherein the first notification sent to the first telephone results in the telephone of the first telephone user ringing if the telephone of the first telephone user is on-hook when the first notification is communicated to the telephone of the first telephone user, wherein if the first telephone user answers the telephone in response to the ringing, a communication link will be re-established between the first telephone user and the party.

18. The apparatus of claim 17, wherein when the telephone of the first telephone user rings in response to the first notification sent to the first telephone, the ring is distinguishable from a ring normally produced by the telephone of the first telephone user when calls are received by the telephone of the first telephone user.

19. A method for providing a reverse-hold feature that enables a first telephone user who has been placed on hold to be notified when the hold has been removed, the method comprising the steps of:
receiving an output signal indicating that one or more keys on a telephone of the first telephone user have been actuated;
interpreting the received output signal to determine whether the received output signal corresponds to a request to activate a reverse-hold feature;
if a determination is made that the received output signal corresponds to a request to activate the reverse-hold feature, activating a reverse-hold feature, wherein activation of the reverse-hold feature enables the first telephone user to be notified when the hold has been removed.

20. The method of claim 19, wherein, while the reverse-hold feature is activated, the first telephone user can hang up the telephone without severing a communication link between the first and second telephone users.

21. The method of claim 19, wherein, while the reverse-hold feature is activated, the first telephone user can make another telephone call without severing a communication link between the first and second telephone users.

22. The method of claim 19, wherein, while the reverse-hold feature is activated, a message is communicated to the party that placed the first telephone user on hold to inform the party of how to re-establish communications with the first telephone user, and wherein if the hold is removed while the reverse-hold feature is activated, a determination will be made as to whether or not one or more signals interpreted by the processor indicate that the party has entered a request to provide notification to the first telephone user that the hold has been removed, wherein if a determination is made that the party has entered a request to provide notification to the first telephone user that the hold has been removed, a first notification is generated and communicated to the telephone of the first telephone user to inform the first telephone user that the hold has been removed.

23. A computer program for providing a reverse-hold feature that enables a first telephone user who has been placed on hold be notified when the hold has been removed, the computer program being embodied on a computer-readable medium, the computer program comprising:
a first code segment, the first code segment interpreting a first signal to determine whether the first signal corresponds to a request to activate a reverse-hold feature;
a second code segment, the second code segment causing the first telephone user to be notified that the hold has been removed when a determination is made by the first code segment that the output signal corresponds to a request to activate a reverse-hold feature.
